(19) United States
(12) Patent Application Publication
(10) Pub. No.: US 2025/0048262 A1
(43) Pub. Date: Feb. 6, 2025

(54) PAGING REST PERIOD

(71) Applicant: Nokia Technologies Oy, Espoo (FI)

(72) Inventors: Antti Anton TOSKALA, Espoo (FI); Srinivasan SELVAGANAPATHY, Bangalore (IN); Rapeepat RATASUK, Inverness, NJ (US)

(21) Appl. No.: 18/837,044

(22) PCT Filed: Jan. 20, 2023
(86) PCT No.: PCT/IB2023/050515

§ 371 Date: Aug. 8, 2024

(30) Foreign Application Priority Data
Feb. 11, 2022 (IN) 202241007306

(51) Int. Cl. H04W 52/02; H04W 68/02; H04W 76/27; H04W 76/28

(52) U.S. Cl. CPC H04W 52/0216; H04W 68/02; H04W 76/27; H04W 76/28

(57) ABSTRACT

According to an example embodiment, a client device includes at least one processor and at least one memory including computer program code, the at least one memory and the computer program code being configured to, with the at least one processor, cause the client device to: transmit a rest period start indication to a network node device, wherein the rest period start indication indicates a start of a rest period during which the client device will not respond to discontinuous reception paging; during the rest period, cease performing discontinuous reception paging with the network node device; and after the rest period, resume discontinuous reception paging with the network node device.

### TECHNICAL FIELD

The present application generally relates to the field of wireless communications. In particular, the present application relates to a client device, a network node device, related methods and computer programs.

### BACKGROUND

Reduced Capability (RedCap) new radio (NR) devices are being introduced. RedCap devices have lower cost and complexity compared to other NR devices and are intended for, for example, internet of things (IoT) use cases such as industrial sensors, wearables, and video transmissions. Further enhancements are being considered for RedCap devise, including enhancements in the area of energy efficiency/power saving. For many RedCap use cases, such as industrial sensors, the traffic is mostly uplink centric with infrequent data transmissions. In this case, DRX plays an important role in determining the battery life of the device. Therefore, further optimization related to DRX can bring significant benefit in reducing power consumption and increasing battery life.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a client device comprises at least one processor and at least one memory comprising computer program code. The at least one memory and the computer program code are configured to, with the at least one processor, cause the client device to: transmit a rest period start indication to a network node device, wherein the rest period start indication indicates a start of a rest period during which the client device will not respond to discontinuous reception paging; during the rest period, cease performing discontinuous reception paging with the network node device; and after the rest period, resume discontinuous reception paging with the network node device. The client device can, for example, reduce power consumption of the client device by ceasing the discontinuous reception paging during the rest period.

An example embodiment of a client device comprises means for performing: transmit a rest period start indication to a network node device, wherein the rest period start indication indicates a start of a rest period during which the client device will not respond to discontinuous reception paging; during the rest period, cease performing discontinuous reception paging with the network node device; and after the rest period, resume discontinuous reception paging with the network node device.

In an example embodiment, alternatively or in addition to the above-described example embodiments, the at least one memory and the computer program code are further configured to, with the at least one processor, cause the client device to: obtain a rest period trigger from an application; and transmit the rest period start indication to the network node device in response to the rest period trigger. The client device can, for example, trigger the rest period when it is appropriate according to the application.

In another example embodiment, alternatively or in addition to the above-described example embodiments, the rest period start indication further indicates a duration of the rest period in terms of discontinuous reception cycles. The client device can, for example, efficiently indicate the duration of the rest period to the network node device. In another example embodiment, alternatively or in addition to the above-described example embodiments, the at least one memory and the computer program code are further configured to, with the at least one processor, cause the client device to cease performing radio measurements during the rest period. The client device can, for example, further reduce the power consumption of the client device.

In another example embodiment, alternatively or in addition to the above-described example embodiments, the at least one memory and the computer program code are further configured to, with the at least one processor, cause the client device to, after the rest period, resume the discontinuous reception paging using paging parameters and paging occasions configured before the rest period. The client device can, for example, efficiently resume the discontinuous reception paging.

In another example embodiment, alternatively or in addition to the above-described example embodiments, the at least one memory and the computer program code are further configured to, with the at least one processor, cause the client device to, before obtaining the rest period trigger, perform an application transaction with the network node device. The client device can, for example, perform needed application transactions before the rest period.

In another example embodiment, alternatively or in addition to the above-described example embodiments, the rest period start indication indicates to the network node device that the rest period starts when the application transactions are completed. The client device can, for example, initiate the rest period once the application transaction has been completed thus reducing the power consumption of the client device while still enabling the application transaction.

In another example embodiment, alternatively or in addition to the above-described example embodiments, the at least one memory and the computer program code are further configured to, with the at least one processor, cause the client device to, in response to client-originated traffic during the rest period, cancel the rest period. The client device can, for example, reduce the power consumption of the client device via the rest period while being able to transmit data if needed during the rest period.

In another example embodiment, alternatively or in addition to the above-described example embodiments, the at least one memory and the computer program code are further configured to, with the at least one processor, cause the client device to indicate the cancellation of the rest period to the network node device. The client device can, for example, reduce the power consumption of the client device via the rest period while being able to transmit data if needed during the rest period and indicate this to the network node device accordingly.

In another example embodiment, alternatively or in addition to the above-described example embodiments, the at least one memory and the computer program code are further configured to, with the at least one processor, cause the client device to switch to RRC_idle or RRC_inactive mode for a duration of the rest period. The client device can, for example, utilise the RRC_idle and RRC_inactive modes during the rest period.

In another example embodiment, alternatively or in addition to the above-described example embodiments, the at least one memory and the computer program code are further configured to, with the at least one processor, cause the client device to switch to the RRC_idle mode for the duration of the rest period in response to the duration of the rest period begin greater than a threshold rest period duration and to switch to the RRC_inactive mode for the duration of the rest period in response to the duration of the rest period begin less than the threshold rest period duration. The client device can, for example, utilise the appropriate mode based on the duration of the rest period.

In another example embodiment, alternatively or in addition to the above-described example embodiments, the at least one memory and the computer program code are further configured to, with the at least one processor, cause the client device to be in RRC_connected mode before the rest period and/or after the rest period. The client device can, for example, utilise the RRC_connected mode before and/or after the rest period.

In another example embodiment, alternatively or in addition to the above-described example embodiments, the client device comprises a reduced capability device. The client device can, for example, reduce the power consumption of the client device, which is important for a reduced capability device.

An example embodiment of a network node device comprises at least one processor and at least one memory comprising computer program code. The at least one memory and the computer program code are configured to, with the at least one processor, cause the network node device to: receive a rest period start indication from a client device, wherein the rest period start indication indicates a start of a rest period during which the client device will not respond to discontinuous reception paging; during the rest period, cease performing discontinuous paging with the client device; and after the rest period, resume discontinuous reception paging with the client device.

An example embodiment of a network node device comprises means for performing: receive a rest period start indication from a client device, wherein the rest period start indication indicates a start of a rest period during which the client device will not respond to discontinuous reception paging; during the rest period, cease performing discontinuous paging with the client device; and after the rest period, resume discontinuous reception paging with the client device. The network node device can, for example, react appropriately during the rest period of the client device when the client device does not respond to discontinuous reception paging.

An example embodiment of a method comprises: transmitting a rest period start indication to the network node device, wherein the rest period start indication indicates a start of a rest period during which the client device will not respond to discontinuous reception paging; during the rest period, ceasing to perform discontinuous reception paging with the network node device; and after the rest period, resuming discontinuous reception paging with the network node device.

An example embodiment of a method comprises: receiving a rest period start indication from the client device, wherein the rest period start indication indicates a start of a rest period during which the client device will not respond to discontinuous reception paging; during the rest period, ceasing to perform discontinuous paging with the client device; and after the rest period, resuming discontinuous reception paging with the client device.

An example embodiment of a computer program product comprises program code configured to perform the method according to any of the above example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example embodiment of the subject matter described herein illustrating a client device;

FIG. 2 illustrates an example embodiment of the subject matter described herein illustrating a network node device;

FIG. 3 illustrates an example embodiment of the subject matter described herein illustrating a signalling diagram;

FIG. 4 illustrates an example embodiment of the subject matter described herein illustrating another signalling diagram;

FIG. 5 illustrates an example embodiment of the subject matter described herein illustrating a rest or sleep period;

FIG. 6 illustrates an example embodiment of the subject matter described herein illustrating a flow chart representation of a method; and

FIG. 7 illustrates an example embodiment of the subject matter described herein illustrating a flow chart representation of another method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

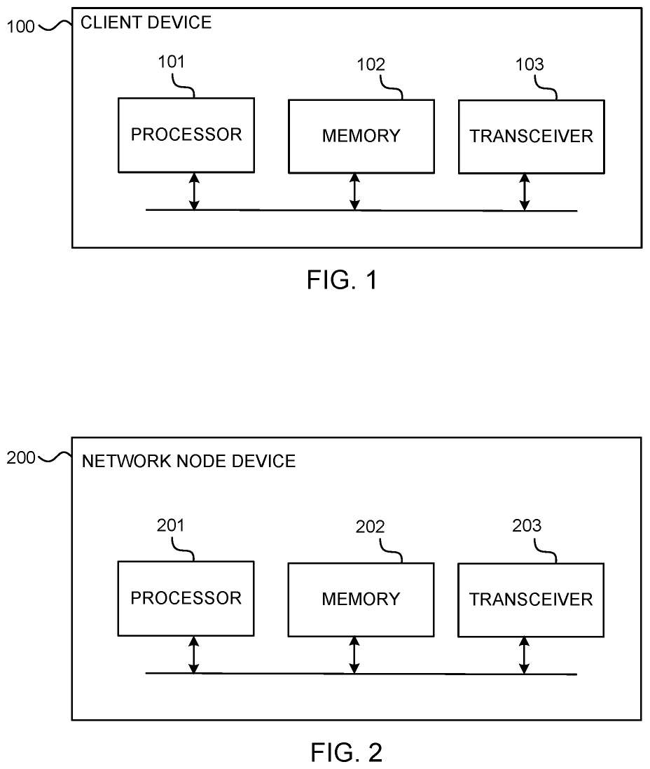

FIG. 1 is a block diagram of a client device 100 configured in accordance with an example embodiment.

The client device 100 may comprise one or more processors 101 and one or more memories 102 that comprise computer program code. The client device 100 may also comprise at least one transceiver 103, as well as other elements, such as an input/output module (not shown in FIG. 1), and/or a communication interface (not shown in FIG. 1).

According to an example embodiment, the client device 100 is configured to transmit a rest period start indication to a network node device, wherein the rest period start indication indicates a start of a rest period during which the client device will not respond to discontinuous reception paging.

In some example embodiments, the client device 100 may be further configured to, before obtaining the rest period trigger, perform an application transaction with the network node device.

The application transaction may comprise one or more transactions related to one or more applications. Each application may correspond to, for example, a client software running on the client device 100 and a server software running on a server to which the network node device provides access for the client device 100.

In some example embodiments, the client device 100 may be configured to obtain a rest period trigger from an application and transmit the rest period start indication to the network node device in response to the rest period trigger.

The application may correspond to, for example, the application transaction.

The rest period start indication may indicate the start of the rest period in various ways, such as those disclosed herein. For example, the client device 100 may transmit the rest period start indication when the application transactions have been completed and the rest period start indication may indicate that the rest period starts substantially immediately. Alternatively, the client device 100 may transmit the rest period start indication before the application transactions have been completed and the rest period start indication may indicate that the rest period starts once the application transactions have been completed.

The rest period start indication may be also configured to be linked with the transition from the RRC_Connected state to either RRC_inactive or to RRC_idle. In such example embodiments, the rest period duration can be determined between the client device 100 and the network earlier and the rest period can be started automatically once the state transition from RRC_connected takes place, for example once the data transmission has stopped and possibly once a timer for state transition expires. In this case, the rest period duration can be either as assistance data from the client device 100 to the network node device earlier, or the client device 100 can signal the rest period duration, either providing any value or selecting from a list of allowed values.

The client device 100 may be further configured to, during the rest period, cease performing discontinuous reception paging (e.g. to stop monitoring for a paging message during paging occasions defined in discontinuous reception) with the network node device.

The client device 100 may also be configured to stop various other operations that consume power, such as radio measurements (e.g. Radio Resource Management measurements), for the duration of the rest period.

The client device 100 may be further configured to after the rest period, resume discontinuous reception paging with the network node device.

Although the client device 100 may be depicted to comprise only one processor 101, the client device 100 may comprise more processors. In an example embodiment, the memory 102 is capable of storing instructions, such as an operating system and/or various applications.

Furthermore, the processor 101 may be capable of executing the stored instructions. In an example embodiment, the processor 101 may be embodied as a multi-core processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute hard-coded functionality. In an example embodiment, the processor 101 is embodied as an executor of software instructions, wherein the instructions may specifically configure the processor 101 to perform the algorithms and/or operations described herein when the instructions are executed.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

When the client device 100 is configured to implement some functionality, some component and/or components of the client device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the client device 100 is configured to perform an operation, the at least one memory 102 and the computer program code can be configured to, with the at least one processor 101, cause the client device 100 to perform that operation.

According to an example embodiment, the client device 100 comprises a reduced capability (RedCap) device. For example, the client device 100 may comprise a device for internet of things (IoT) applications, such as an industrial sensor, a wearable device, or a video transmissions device.

The client device 100 may comprise, for example, a mobile phone, a smartphone, a tablet computer, a smart watch, or any hand-held or portable device or any other apparatus, such as a vehicle, a robot, or a repeater. The client device 100 may also be referred to as a user equipment (UE) or similar.

Some terminology used herein may follow the naming scheme of 4G or 5G technology in its current form. However, this terminology should not be considered limiting, and the terminology may change over time. Thus, the following discussion regarding any example embodiment may also apply to other technologies.

FIG. 2 illustrates an example embodiment of the subject matter described herein illustrating a network node device 200.

The network node device 200 may comprise one or more processors 201 and one or more memories 202 that comprise computer program code. The network node device 200 may also comprise at least one transceiver 203, as well as other elements, such as an input/output module (not shown in FIG. 2), and/or a communication interface (not shown in FIG. 2).

According to an example embodiment, the at least one memory 202 and the computer program code are configured to, with the at least one processor 201, cause the network node device 200 to receive a rest period start indication from the client device 100, wherein the rest period start indication indicates a start of a rest period during which the client device will not respond to discontinuous reception paging.

The network node device 200 may be further configured to during the rest period, cease performing discontinuous paging with the client device 100.

The network node device 200 may be further configured to after the rest period, resume discontinuous reception paging with the client device 100.

Furthermore, the processor 201 may be capable of executing the stored instructions. In an example embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 201 may be configured to execute hard-coded functionality. In an example embodiment, the processor 201 is embodied as an executor of software instructions, wherein the instructions may specifically configure the processor 201 to perform the algorithms and/or operations described herein when the instructions are executed.

The memory 202 may be embodied as one or more volatile memory devices, one or more non-volatile memory devices, and/or a combination of one or more volatile memory devices and non-volatile memory devices. For example, the memory 202 may be embodied as semiconductor memories (such as mask ROM, PROM (programmable ROM), EPROM (erasable PROM), flash ROM, RAM (random access memory), etc.).

The network node device 200 may be embodied in, for example, a base station (BS). The base station may comprise, for example, a gNodeB (gNB) or any such device providing an air interface for client devices to connect to the wireless network via wireless transmissions.

When the network node device 200 is configured to implement some functionality, some component and/or components of the network node device 200, such as the at least one processor 201 and/or the memory 202, may be configured to implement this functionality. Furthermore, when the at least one processor 201 is configured to implement some functionality, this functionality may be implemented using program code comprised, for example, in the memory 202. For example, if the network node device 200 is configured to perform an operation, the at least one memory 202 and the computer program code can be configured to, with the at least one processor 201, cause the network node device 200 to perform that operation.

The client device 100 and/or the network node device 200 can improve DRX in, for example, RedCap applications. In many RedCap applications, once the transaction with the application server is over, there is no foreseen immediate need to be reachable. The discussed example range covers from industrial sensors, thrash container level indication or temperature sensors. In all these cases it is common that the power consumption is important and the client device 100 would not need to be immediately accessible once the transaction with the application server is completed. This could be either UE application initiated transaction (temperature change, waste container level update etc.) or the network polling the situation from the application.

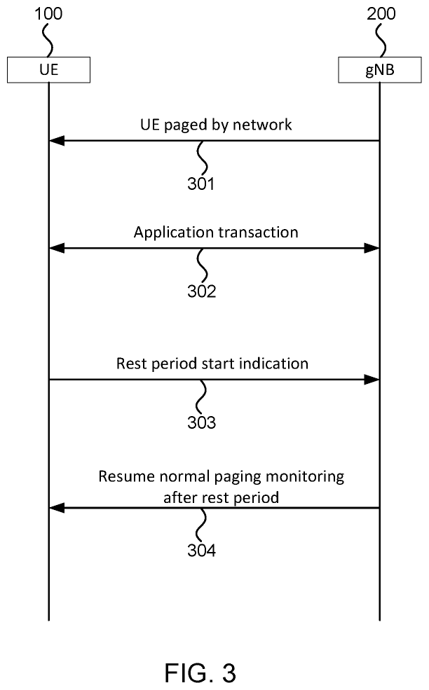

FIG. 3 illustrates an example embodiment of the subject matter described herein illustrating a signalling diagram.

The network node device 200 can page 301 the client device 100. Then, the client device 100 and the network node device 200 can perform an application transaction 302.

After the application transaction 302 is completed, the client device 100 can inform the network node device 200 to enter the rest period. The client device 100 can transmit a rest period indication 303 to the network node device 200.

According to an example embodiment, the rest period start indication 303 indicates to the network node device 200 that the rest period starts when the application transactions 302 are completed.

According to an example embodiment, the rest period start indication 303 further indicates a duration of the rest period in terms of discontinuous reception cycles. The rest period indication 303 can indicate, for example in connection with application activity completed, to skip N DRX periods. In some embodiments, the rest period start indication 303 may indicate one or more other parameters or behaviours associated with the rest period.

In other example embodiments, the duration of the rest period can be preconfigured. In such cases, the client device 100 can enter into the rest period without receiving an explicit acknowledgement for the rest period start indication or the client device 100 can enter into the rest period after release of RRC connection once application acknowledgement is received.

According to an example embodiment, the client device 100 is further configured to resume the discontinuous reception paging using paging parameters and paging occasions configured before the rest period.

According to an example embodiment, the network node device 200 is further configured to resume the discontinuous reception paging using paging parameters and paging occasions configured before the rest period.

Once resuming 304 (recovering) operation (unless the client device 100 initiated activity), such as normal paging monitoring, the client device 100 and the network node device 200 can follow earlier configured paging parameters and paging occasion.

According to an example embodiment, the client device is further configured to switch to RRC_idle or RRC_inactive mode for a duration of the rest period.

During the rest period, the client device 100 can move to RRC_idle or RRC_inactive. For example, if the rest period is relatively short, RRC_inactive may be used.

According to an example embodiment, the client device 100 is further configured to switch to the RRC_idle mode for the duration of the rest period in response to the duration of the rest period begin greater than a threshold rest period duration and to switch to the RRC_inactive mode for the duration of the rest period in response to the duration of the rest period begin less than the threshold rest period duration.

According to an example embodiment, the client device is further configured to be in RRC_connected mode before the rest period and/or after the rest period.

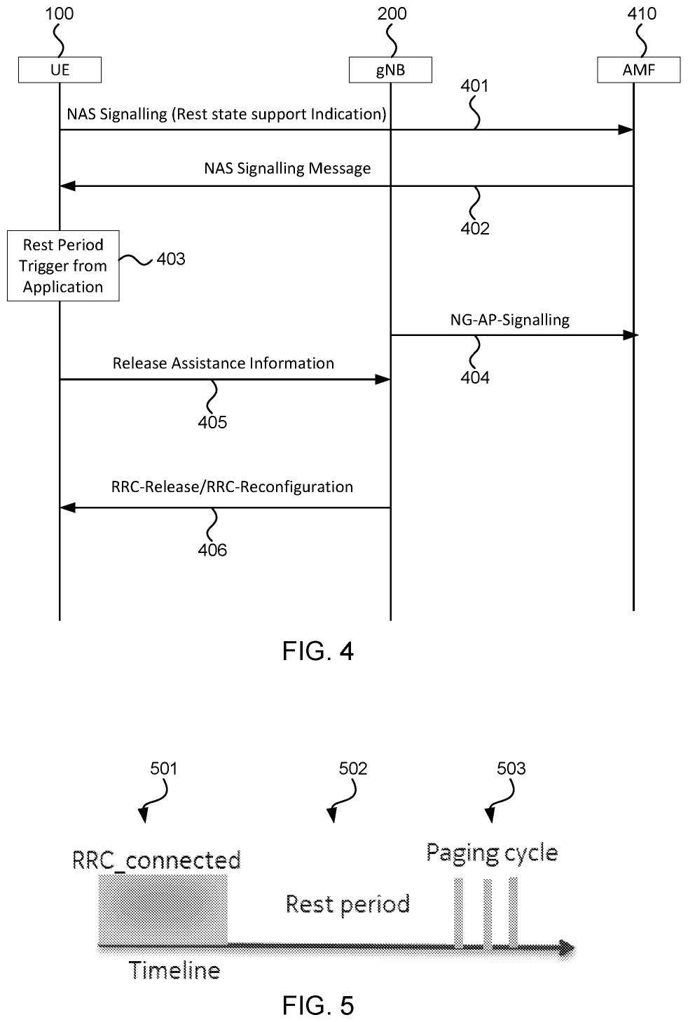

FIG. 4 illustrates an example embodiment of the subject matter described herein illustrating another signalling diagram.

The client device 100 can perform Non-Access Stratum (NAS) signalling 401 to the access and mobility management function (AMF) 410. The NAS signalling 401 can comprise, for example, a rest state support indication.

The AMF 410 can transmit a NAS signalling message 402 to the client device 100. The NAS signalling message 402 may comprise, for example, a new rest state configuration, rest period configurations, such as fixed/dynamic rest period and/or a period to code mapping, and/or rest behaviour configurations, such as Action-code, No monitoring, N:1 Monitoring, ON/OFF window.

The client device 100 can obtain a rest period trigger 403 from an application.

The network node device 200 can transmit a new generation access stratum (NG-AP) signalling message 404 to the AMF 410. The NG-AP-Signalling message 404 can comprise, for example, Rest Configuration and/or a Context Setup or Context Release message.

The client device 100 can transmit Release Assistance Information 405 to the network node device 200. The Release Assistance Information 405 can comprise, for example, a Rest-configuration-activated indicator comprising, for example, a Period-Indication and/or an Action-code.

The network node device 200 can transmit RRC-Release/RRC-Reconfiguration 406 to the client device 100. The RRC-Release/RRC-Reconfiguration 406, can comprise, for example, a Rest-config-ACK.

The client device 100 and/or the network node device 200 can provide further power savings with the help of the application if the application server also does not try to poll the client device 100 until the rest period is over. This is relatively easy to implement in the network as the existing DRX cycle can be maintained.

According to an example embodiment, the client device 100 is further configured to cease performing radio measurements during the rest period. This may be referred to as measurement relaxation.

Since the network node device 200 is aware of the rest period, the network node device 200 can delay paging and understand why the client device 100 does not respond if paged during the rest period.

The client device 100 and/or the network node device 200 can give an application greater control of the battery life of the client device 100. An application can, upon detecting power or battery level getting low, adapt the rest period to be longer than earlier in order to save power.

In some example embodiments, the client device 100 may be configured to change the paging reception pattern, if the client device 100 is configured with DRX monitoring. The DRX cycle may be cell specific.

In some example embodiments, the activation of the rest period may be dynamic. The duration of the rest period may be fixed or dynamic.

In some example embodiments, there may be an ON/OFF pattern configuration over a DRX cycle. The rest period may be periodic similar to ON duration of Connected Mode Discontinuous Reception (C-DRX). This could allow known periods of reachability while still having application-dependent longer periods of non-availability.

In some example embodiments, paging occasion (PO) may be changed dynamically for monitoring without changing the DRX cycle. For example, switch from every DRX cycle monitoring to 1:10 DRX cycle monitoring.

In some example embodiments, a network- and/or client-initiated fallback mechanism can be utilised.

According to an example embodiment, the client device 100 is further configured to, in response to client-originated traffic during the rest period, cancel the rest period.

In some example embodiments, the client device 100 may be configured to, in response to client-originated traffic during the rest period, continue the rest period. For example, such a client-originated transfer can indicate to continue the rest period if, for example, the client-originated transfer is due to exception reporting.

In case of mobile-originated traffic during the rest period, the rest state configuration may be cancelled even if the UE does not transition to RRC_Connected state.

FIG. 5 illustrates an example embodiment of the subject matter described herein illustrating a rest period.

The client device 100 may first be in RCC_connected mode 501 before the rest period 502 as illustrated in the example embodiment of FIG. 5.

The rest period 502 may start at a time indicated by the rest period start indication 303 transmitted by the client device 100. The duration of the rest period 502 may also be indicated by the rest period start indication 303. As can be seen from the example embodiment of FIG. 5, there may be no DRX paging during the rest period 502.

After the rest period 502, the client device 100 and the network node device 200 may continue the DRX paging 503 as illustrated in the example embodiment of FIG. 5.

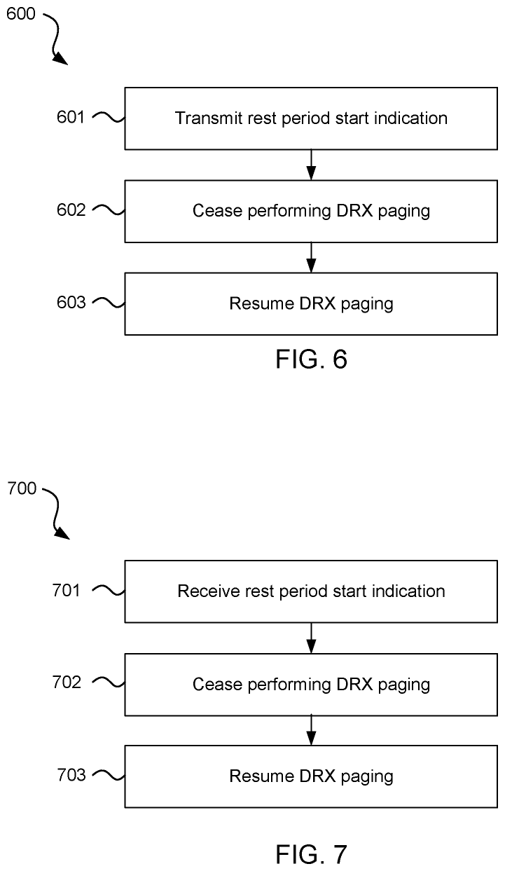

FIG. 6 illustrates an example embodiment of the subject matter described herein illustrating a flow chart representation of a method.

According to an example embodiment, the method 600 comprises transmitting 601 a rest period start indication to the network node device, wherein the rest period start indication indicates a start of a rest period during which the client device will not respond to discontinuous reception paging.

The method 600 may further comprise during the rest period, ceasing 602 to perform discontinuous reception paging with the network node device.

The method 600 may further comprise after the rest period, resuming 603 discontinuous reception paging with the network node device.

The method 600 may be performed by, for example, the client device 100.

FIG. 7 illustrates an example embodiment of the subject matter described herein illustrating a flow chart representation of another method.

According to an example embodiment, the method 700 comprises receiving 701 a rest period start indication from the client device, wherein the rest period start indication indicates a start of a rest period during which the client device will not respond to discontinuous reception paging;

The method 700 may further comprise, during the rest period, ceasing 702 to perform discontinuous paging with the client device.

The method 700 may further comprise, after the rest period, resuming 703 discontinuous reception paging with the client device.

The method 700 may be performed by, for example, the network node device 200.

An apparatus may comprise means for performing any aspect of the method(s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the network node device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1.-17. (canceled)

18. A client device, comprising:
at least one processor; and
at least one memory including computer program code;
the at least one memory and the computer program code configured to, with the at least one processor, cause the client device to:
transmit a rest period start indication to a network node device, wherein the rest period start indication indicates a start of a rest period during which the client device will not respond to discontinuous reception paging;
during the rest period, cease performing discontinuous reception paging with the network node device; and
after the rest period, resume discontinuous reception paging with the network node device.

19. The client device according to claim 18, wherein the at least one memory and the computer program code are further configured to, with the at least one processor, cause the client device to:
obtain a rest period trigger from an application; and
transmit the rest period start indication to the network node device in response to the rest period trigger.

20. The client device according to claim 18, wherein the rest period start indication further indicates a duration of the rest period in terms of discontinuous reception cycles.

21. The client device according to claim 18, wherein the at least one memory and the computer program code are further configured to, with the at least one processor, cause the client device to cease performing radio measurements during the rest period.

22. The client device according claim 18, wherein the at least one memory and the computer program code are further configured to, with the at least one processor, cause the client device to, after the rest period, resume the discontinuous reception paging using paging parameters and paging occasions configured before the rest period.

23. The client device according to claim 18 wherein the at least one memory and the computer program code are further configured to, with the at least one processor, cause the client device to, be-fore obtaining the rest period trigger, perform an application transaction with the network node device.

24. The client device according to claim 23, wherein the rest period start indication indicates to the network node device that the rest period starts when the application transactions are completed.

25. The client device according to claim 18, wherein the at least one memory and the computer program code are further configured to, with the at least one processor, cause the client device to, in response to client-originated traffic during the rest period, cancel the rest period.

26. The client device according to claim 23, wherein the at least one memory and the computer program code are further configured to, with the at least one processor, cause the client device to indicate the cancellation of the rest period to the network node device.

27. The client device according to claim 18, where-in the at least one memory and the computer program code are further con-figured to, with the at least one processor, cause the client device to switch to RRC_idle or RRC_inactive mode for a duration of the rest period.

28. The client device according to claim 27, wherein the at least one memory and the computer program code are further configured to, with the at least one processor, cause the client device to switch to the RRC_idle mode for the duration of the rest period in response to the duration of the rest period begin greater than a threshold rest period duration and to switch to the RRC_inactive mode for the duration of the rest period in response to the duration of the rest period begin less than the threshold rest period duration.

29. The client device according to claim 18, where-in the at least one memory and the computer program code are further con-figured to, with the at least one processor, cause the client device to be in RRC_connected mode before the rest period and/or after the rest period.

30. The client device according claim 18, wherein the client device comprises a reduced capability device.

31. A network node device comprising:
at least one processor; and
at least one memory including computer program code;
the at least one memory and the computer program code configured to, with the at least one processor, cause the network node device to:
receive a rest period start indication from a client device, wherein the rest period start indication indicates a start of a rest period during which the client device will not respond to discontinuous reception paging;
during the rest period, cease performing discontinuous paging with the client device; and
after the rest period, resume discontinuous reception paging with the client device.

32. A method comprising:
transmitting a rest period start indication to the network node device, wherein the rest period start indication indicates a start of a rest period during which the client device will not respond to discontinuous reception paging;
during the rest period, ceasing to perform discontinuous reception paging with the network node device; and
after the rest period, resuming discontinuous reception paging with the network node device.
